(19) United States
(12) Patent Application Publication
(10) Pub. No.: US 2001/0051999 A1
(43) Pub. Date: Dec. 13, 2001

(54) Apparatus for selecting services and internet providers for broadband applications

(76) Inventors: Rudiger Hnyk, Munchen (DE); Johannes Krupp, Bad Aibling (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/803,436

(22) Filed: Mar. 9, 2001

(30) Foreign Application Priority Data
Mar. 9, 2000 (DE) 100 11 527.6

(51) Int. Cl. G06F 15/16; G06F 15/173

(52) U.S. Cl. 709/218; 709/238

(57) ABSTRACT

In the prior art, broadband terminals are supplied to the Internet via an associated router. Incorporated between the router and the Internet are selection servers for selecting services (Service Selection) which are used to handle the entire traffic for the Internet. A problem with this is that the selection server is configured in the communication path to the Internet, which means that the dynamics of access are reduced. The invention provides a remedy for this by arranging the selection server parallel to the router, which removes it from the path between the router and the Internet.

### BACKGROUND OF THE INVENTION

1. Field of the Invention

The invention relates to an apparatus for transferring information to an Internet. The apparatus includes a router having a communication path to the Internet, and a selection server acting as an interface to the Internet.

In the prior art, the terminals of a broadband subscriber are supplied to a router using a communication system. In this context, the communication system can be regarded as part of a telephone exchange and forms the termination up to level 2. Connected downstream of the communication system is a router. Other network units of an access network are also configured between the communication system and the router. Selection servers are linked into the connections between the router and the Internet. The selection server has the task of selecting the service desired by the subscriber (Service Selection). In this regard, trunk selection, path selection (e.g. in the case of ATM/FR VC or MPLS connections) or address selection (e.g. using the IP destination address) and also billing of the end subscriber need to be carried out.

A problem with such a configuration is that the selection server is configured in the communication path to the Internet. This means that a number of subscribers are routed through one and the same selection server to the Internet. However, this presents the risk that the selection server will be a bottleneck, and the dynamics of access will be reduced.

### SUMMARY OF THE INVENTION

It is accordingly an object of the invention to provide a network configuration which overcomes the above-mentioned disadvantageous of the prior art apparatus of this general type, and with which the dynamics of access to the Internet are increased for all end subscribers.

With the foregoing and other objects in view there is provided, in accordance with the invention, an apparatus for transferring information to the Internet. The apparatus includes a router having a communication path to the Internet, and a selection server acting as an interface to the Internet. The selection server is configured parallel to the router so that the selection server is not in the communication path between the router and the Internet.

In accordance with an added feature of the invention, the router and the selection server are configured to interchange a communication protocol.

In accordance with a concomitant feature of the invention, the communication protocol is designed such that suitable data structures are provided between the router and the selection server for controlling a response of the router.

A particular advantage of the invention is that the selection server is removed from the path entirely and is configured next to the router. This decouples the router and the server.

Advantageous developments of the invention are specified in the dependent claims.

Other features which are considered as characteristic for the invention are set forth in the appended claims.

Although the invention is illustrated and described herein as embodied in an apparatus for selecting services and Internet providers for broadband applications, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows the network structure in accordance with the invention; and

FIG. 2 shows the protocol to be interchanged between the router and the selection server.

### DESCRIPTION OF THE PREFERRED EMBODIMENTS

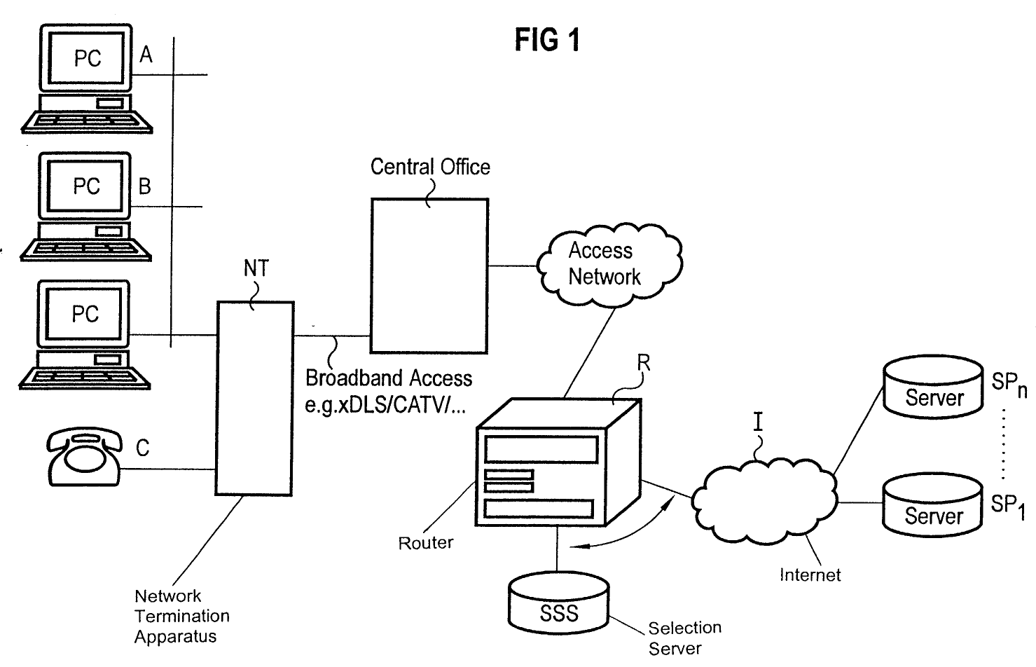

Referring now to the figures of the drawing in detail and first, particularly, to FIG. 1 thereof, there is shown subscribers A, B, C that are connected to a network termination apparatus NT by a common bus. All of the subscribers have a personal computer PC as a terminal. The network termination apparatus NT is connected to a communication system via a broadband access facility. This communication system terminates all subscribers up to level 2. The connections leaving the subscribers A, B, C are logically terminated (level 3) by a router R connected to the communication system by other network components in an access network.

The router R now has a direct connection to the selection server SSS (Service Selection Server). This selection server is configured next to the router R. In addition, the router R is connected to the Internet I by direct connections. Other servers are configured on the Internet, which store video films, for example. These are operated by service providers SP₁ . . . SP_{N}.

If the subscribers A, B, C now connect to the Internet I, in order, for example, to view the film from a video provider, the connection to the router R is first set up. The router transfers information in a protocol P to the selection server SSS, and the latter uses this protocol to ascertain trunk selection, path selection, address selection, and billing. Subsequently, the appropriate connections to the Internet I are then switched through to the service providers SP₁ . . . SP_{N}. The selection server SSS has thus been removed from the path, which means that there is no longer any bottleneck for the subscribers. This speeds up the transfer operations from and to the Internet I.

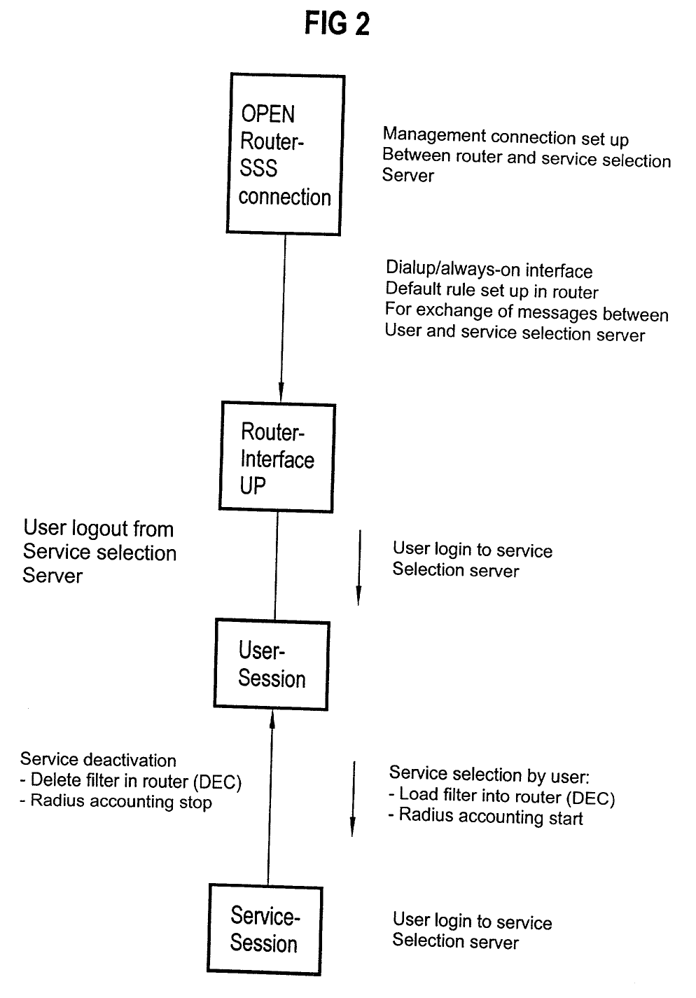

FIG. 2 shows the protocol which is to be interchanged between the router and the selection server. A subscriber wanting to use the services of one or more service providers SP₁ . . . SP_{N} first logs on to the selection server SSS via the router R. The selection server checks (e.g. using a database) which of the service providers SP₁ . . . SP_{N} there are and notifies the subscriber of this. The subscriber can then select one or more of the service providers SP₁ . . . SP_{N} and notify the selection server SSS of this via the router R. The selection server SSS then decides whether or not to accept the setup of a connection to the service provider SPₓ. The necessary data structures (filter rules) are then passed to the router R in a decision message (DEC), and the appropriate rules are activated on the router R. The success of this action is acknowledged to the selection server SSS by the router R using a report message (RPT).

If the subscriber no longer requires the respective service provider SP₁ . . . SP_{N} selected, he can notify the selection server SSS of this fact. The selection server then resets the affected filter rules in a decision message (DEC). The success of this action is acknowledged by the router R likewise using a report message (RPT).

In addition, the selection server SSS can request billing data from the router R as necessary or when a subscriber logs out. This is done by setting a particular marker in the decision message from the router to the selection server SSS; the selection server SSS then returns the requested data in a report message (RPT).

The invention is used essentially for dialup connections. The invention is not restricted to this, however. Thus, the invention may likewise be used for subscribers whose connections do not need to be set up (non-dial connections, always-on connections). The protocol P is then likewise executed in the manner described above.

We claim:

1. An apparatus for transferring information to an Internet, which comprises:
a router having a communication path to an internet; and
a selection server acting as an interface to the Internet;
said selection server configured parallel to said router so that said selection server is not in the communication path between said router and said Internet.

2. The apparatus according to claim 1, wherein said router and said selection server are configured to interchange a communication protocol.

3. The apparatus according to claim 2, wherein the communication protocol is designed such that suitable data structures are provided between said router and said selection server for controlling a response of said router.
